(19) United States
(12) Patent Application Publication
(10) Pub. No.: US 2009/0147358 A1
(43) Pub. Date: Jun. 11, 2009

(54) INTEROCULAR ADJUSTMENT ALIGNMENT CHECK DEVICE

(75) Inventor: Nick Charlesworth, Newcastle-Upon-Tyne (GB)

Correspondence Address: MCKEE, VOORHEES & SEASE, P.L.C., 801 GRAND AVENUE, SUITE 3200, DES MOINES, IA, 50309-2721, US

(73) Assignee: STEREONICS LIMITED, Newcastle-Upon-Tyne (GB)

(21) Appl. No.: 12/160,833

(22) PCT Filed: Jan. 11, 2007
(86) PCT No.: PCT/GB07/00071

§ 371 Date: Oct. 29, 2008

(30) Foreign Application Priority Data
Jan. 13, 2006 (GB) GB0600675.3

(51) Int. Cl. G02B 23/18; G02B 27/02; G02B 25/00

(52) U.S. Cl. 359/481; 359/480; 359/505

(57) ABSTRACT

A viewing device containing one or more display screens and adjustment means to allow the device to be adjusted to suit a user's interocular distance, wherein alignment means are provided to check the alignment of the device with the wearer's eyes.

The invention to which this application relates is viewing devices such as head-mounted displays and ocular glasses.

Although the following description refers almost exclusively to alignment in relation to head-mounted displays, it will be appreciated by persons skilled in the art that the present invention can be used with other viewing devices.

The distance between a person's eyes (usually measured between the centre of the pupils and known as the interocular distance), varies from person to person. When a person wears a head-mounted display, if the distance between the centres of the eyepieces (or the centres of the displays relating to each eyepiece) does not match the person's interocular distance, the person may suffer from problems such as headaches and/or eye-strain and/or incomplete image viewing as a result.

Some devices allow the distance between the eyepieces to be adjusted to match the interocular distance. However, there is a range of distances between the eyepieces in which a person can still look through the same and still retain a full or partial view of the display(s) as appropriate for the layout provided, as the person's brain compensates automatically if the eyes are not aligned with the eyepieces exactly. Thus it is not possible to determine if the eyes are correctly aligned with the eyepieces even if the distance between the eyepieces can be adjusted, and if misaligned, the attempt to compensate leads to the aforementioned problems.

There is a concern that devices which cannot be aligned correctly may give rise to legal claims to compensation for the problems suffered by some users. An additional concern is that devices which are not aligned correctly may lead to a limited commercial exploitation of the product type.

An aim of the present invention is to provide a viewing device in which there is a means for checking the alignment of at least one of the eyepieces with the person's eyes.

In a first aspect of the invention, there is provided a viewing device comprising:
one or more portions, each of said portions provided to be placed adjacent one of a user's eyes;
adjustment means to allow movement of at least one of said portions;
at least one display screen for viewing by the user via said one or more portions;
characterised in that alignment means are provided to check the alignment of at least one portion with the respective eye of the user when optimising viewing of the display via movement of the adjustment means.

In one embodiment at least two spaced portions are provided, each portion including alignment means

In one embodiment the alignment means comprises one or more tubular structures mounted in or on each portion.

Typically each portion is or includes an eyepiece, and includes one or more lenses. Typically the tubular structures are mounted adjacent the at least one display or eyepieces.

In one embodiment each tubular structure defines an aperture therethrough. Typically the user is able to look through the structures simultaneously when the portions are correctly aligned.

It will be appreciated that the narrower and longer the tube, the smaller the field of view therethrough, and thus the more accurate the alignment check.

In a further embodiment each tubular structure is provided with one or more illumination means at the distal end thereof. Typically the user is able to see illumination from the structures simultaneously to determine when the portions are correctly aligned. Typically the illumination means can be switched on for the alignment operation, and switched off thereafter. The tubular structures can thus be open to view an object therethrough or closed at one end when provided with a source of illumination at that end.

Typically the illumination means is an LED but it will be appreciated by those skilled in the art that any suitable illumination source may be used. Typically the display is turned off during the alignment process.

It will be appreciated that different shapes and lengths of tubular structure may be provided to change the sensitivity of the horizontal/vertical view or alignment, and different colours of light and/or shapes of tubular structure may be provided for different mounts of convergence to suit the individual preferences of different users.

In one embodiment one or more arrays of tubular structures are provided, each array including a plurality of tubular structures having different indicators to enable the user to determine the extent of alignment or misalignment of the portions. Typically the indicators are illumination means of different colours. For example green LEDs may be visible when the tubular structures are correctly aligned, with blue LEDs disposed outwardly and red LEDs disposed inwardly of the green LEDs which are visible to the user when the portions are not correctly aligned.

In one embodiment, means are included to increase the path length of the light passing through the tubular structures to the user's eyes, thereby increasing the accuracy of the alignment. Typically the path length increasing means include one or more mirrors.

Thus if there is not enough space to accommodate the tubular structures such that their longitudinal axes are aligned with the user's lines of sight, the tubular structures can be placed elsewhere in the device and mirrors used to divert light therethrough to the user's eyes.

In one embodiment one or more tubular structures are mounted substantially centrally above and/or below each lens or display screen.

In a further embodiment tubular structures are mounted offset outwardly from the centre of the lens or display screen. Thus when the user's eyes are aligned with the structures, the lines of sight from the user's eyes converge slightly, which is a more natural position, as for example used when reading a book.

In a further embodiment one or more tubular structures are mounted to the sides of each lens or display screen to assist with vertical alignment of the portions.

In one embodiment each portion includes a display screen. In one embodiment at least one portion includes one or more markings or other indication means to indicate the central point or preferred alignment position of said at least one portion to allow alignment thereto.

In a further embodiment the viewing device is provided with sensor means to detect a user's interocular distance. Typically the sensor means detect the position of the pupils of the user's eyes.

In one embodiment the viewing device is provided with motor means to allow automatic adjustment of the same to match a user's interocular distance.

Typically the at least one display screen can provide an indication to the user of the configuration of the viewing device.

In one embodiment locking means are provided to lock the distance between the portions when the alignment means are not in use. Thus it is possible to adjust the viewing device during alignment, and when the procedure is finished the viewing device is locked in the correct configuration.

In one embodiment the locking means is activated when the illumination means is switched off, and deactivated when the illumination means is switched on.

In one embodiment the adjustment means allows horizontal, vertical, lateral and/or convergence adjustment of the viewing device relative to the user.

Typically the horizontal adjustment is provided by a rack and pinion mechanism connected to the portions. This allows the viewing device to match the interocular spacing.

Typically the vertical adjustment is provided by a gear mechanism connected to a nose bridge provided on the device. This allows the viewing device to be raised and lowered.

In one embodiment, the nose bridge is provided with adjustable mounting points to ensure that the centre of the device is mid-way between the user's eyes. Thus if the nose of a user is not exactly centred between the user's eyes, which could cause misalignment of the device, this deficiency can be corrected. The mounting points can be locked into place after adjustment.

Typically the lateral adjustment is provided by selectively adjusting the arms of the viewing device. This allows the viewing device to be moved backwards and forwards.

In one embodiment one or more components are rotatably mounted so as to allow rotation of the same as the distance between the portions is adjusted. In a further embodiment the portions are pivotally connected or the display screens are rotationally mounted to allow movement of the same about a substantially vertical axis. In these embodiments it is possible to compensate for comfort or ocular defects.

Thus when the centres of the display screens are closer together than the interocular distance, the viewer's eyes are focused on a point closer than infinity i.e. the lines of sight cross near the user.

In one embodiment the display screens rotate in equal and opposite directions. Typically the mechanism that allows rotation is a simple gear system connected to the horizontal adjustment mechanism.

In one embodiment one or more reference marks may be provided to allow the user to adjust the portions such that the lines of sight of each eye to the at least one display screen are not parallel. Users may find it more comfortable to use the viewing device when the lines of sight of their eyes are converging as in the position when reading a handheld document. Said additional one or more reference marks may be calibrated for precision.

In one embodiment the convergence adjustment allows adjustment for the relative line of sight for each eye when the device includes a single display screen, such that when the adjustment means is adjusted to provide a converging view of the display screen the display screen remains substantially parallel to the user. Typically the convergence adjustment is provided using any or any combination of mirrors, half coated mirrors, beam splitters, prisms, lenses or mechanical rotation of the display, lenses, and/or portions.

It will be appreciated by those skilled in the art that when such convergence adjustment is provided with a single display screen with the alignment means visible to both eyes, a converging arrangement for one eye will indicate a diverging arrangement for the other eye. This can be overcome by providing alignment means for each eye where only the alignment means for a selected eye is visible to that eye.

Thus, in an embodiment containing a single display screen and two eyepieces, two arrays of tubular structures are provided, each array being visible via only one of the eyepieces. Typically one array is arranged above the display screen or top of the eyepiece, and the other array is arranged below the display screen or bottom of the eyepiece. The housing is constructed such that only one array is visible to each eye. Where the tubular structures are provided with illumination means, the view of the illumination means may not be focused, and although this does not necessarily matter for the purposes of alignment, correcting optics may be provided in a further embodiment. In an alternative arrangement where one display is provided the alignment means are located in one of the eyepieces.

In a further embodiment, the convergence adjustment allows adjustment for the relative line of sight for each eye when the device includes more than one display screen. Typically the user would adjust the viewing device such that the line of sight of each eye is substantially parallel. However, the convergence adjustment allows the user to adjust the viewing device to compensate for when the user's lines of sight are not parallel.

Typically the alignment of the portions can be checked while the device is worn by a user.

In an alternative embodiment the viewing device comprises a single portion instead of two portions and the adjustment means allows the distance between the portion and a central point between a user's eyes or other convenient location to be adjusted.

In one embodiment the alignment means comprises one or more apertures the size of which can be selectively changed. Typically the aperture or apertures can be adjusted between a substantially open configuration when the alignment means is not in use, and a configuration with a smaller sized aperture or apertures when in use. For example, an aperture can be circular and change size like an iris, or alternatively can be a slot which is enlarged or reduced similar to opening or closing curtains.

In a further embodiment the alignment means comprises a moveable section provided with a small aperture which can be selectively moved to obscure at least a part of the lens and/or screen.

In one embodiment the alignment means is positioned adjacent the lens of each portion to limit the view of the user when looking through the alignment means when in use. The user can then adjust the distance between the portions to align their eyes with the alignment means and thus allow each eye to look through the lenses.

It will be appreciated by persons skilled in the art that the sensitivity of the alignment means will be related to the size of the aperture thereof. Whilst a very narrow aperture may increase the accuracy of the alignment, it may also increase the difficulty of finding the position in which the viewing device is correctly aligned. Accordingly means may be provided to progressively reduce the size of the aperture in one or more stages as the correct alignment position is approached.

In one embodiment the display screen of each portion can display an alignment indicator to allow the user to align the alignment means with their eyes accurately. For example, a cross may be centrally or otherwise displayed on the display screens, which will only be visible through the alignment means during the alignment process when the portions are correctly aligned with the user's eyes.

In one embodiment the display screens can display an alignment indicator in the form of defined areas, to allow the user to adjust the viewing device for comfort.

Although the invention is described with singular alignment means in each portion, it will be appreciated to those skilled in the art that providing multiple alignment means in each portion can increase the effectiveness of the alignment.

In one embodiment the alignment configuration is displayed on the display screen. Typically the device is provided with memory means to allow the configuration to be recorded. Thus if someone else uses the device and changes the alignment of the device, it will be possible to return the same to its previous state by using the recorded configuration.

In a further aspect of the invention, there is provided an alignment device for an interocularly adjustable viewing device, comprising a tubular structure having a channel therethrough characterised in that when the viewing device is correctly aligned with the user's eyes the aperture of said channel is positioned in front of the user's eyes such that the user can look therethrough.

Typically the alignment is deemed correct if the user can view an object and/or alignment signal though the channels.

Typically the tubular structure is circular in cross-section, but it will be appreciated by those skilled in the art that the cross-section may be any suitable shape. For example a cross-shaped tubular structure may be provided to improve horizontal and vertical alignment. A further example is that the tubular structure is open, such as a U-shape, or other structure without a continuous circumferential surface.

Another example is where the user's line of sight is not in vertical alignment with said alignment tubular structure, perhaps due to the form of the user's head, the tubular structure may be provided with an elliptical cross-section, with a vertical dimension different to that of the horizontal dimension. An increased vertical dimension also means that vertical alignment is less of an issue as such a device then primarily provides for horizontal alignment.

In a yet further aspect of the invention, there is provided a method of aligning an interocularly adjustable viewing device, comprising the steps of:
positioning each of the ocular units included in the viewing device adjacent a person's respective eyes;
moving the ocular units using adjustment means to allow viewing of a display screen provided in the device;
characterised in that the alignment of the ocular units with the person's eyes can be checked with alignment means while moving the adjustment means to optimise viewing of a display screen

Specific embodiments of the invention are now described wherein:—

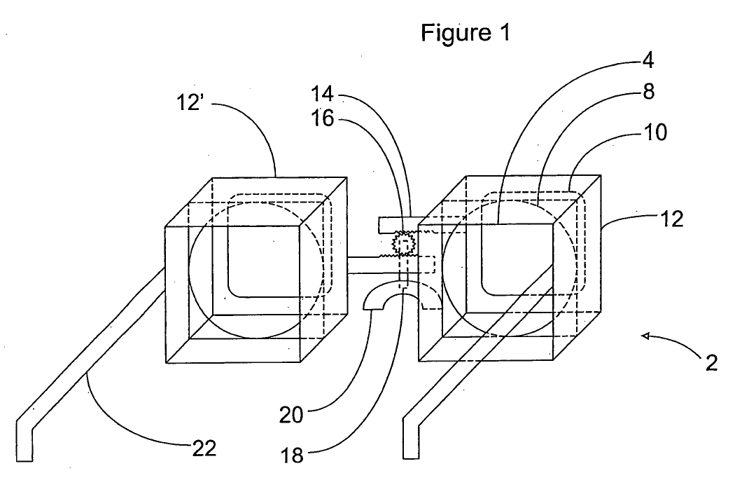

FIG. 1 illustrates a schematic view of an embodiment of a viewing device according to the invention.

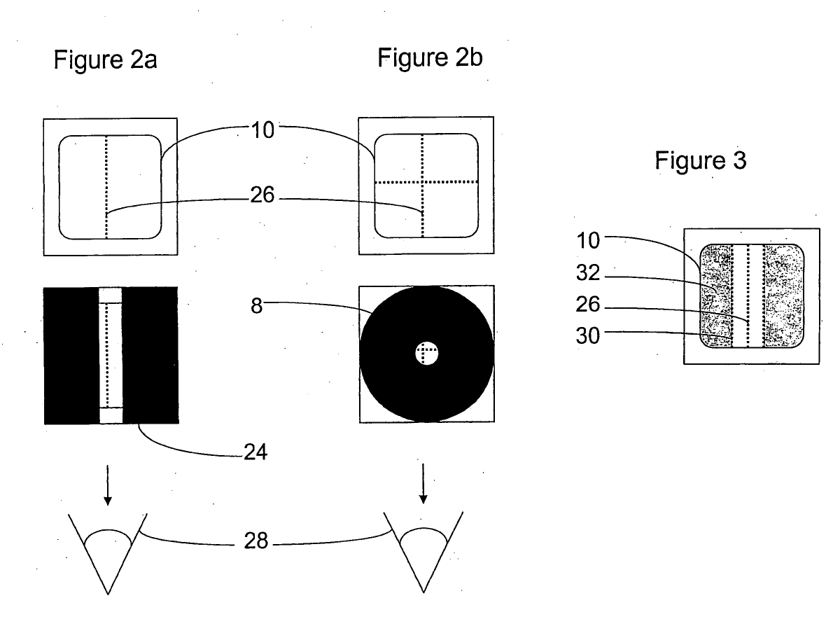

FIG. 2 illustrates a display screen and the alignment means of a viewing device (a) where the alignment means is in the form of an iris (b) where the alignment means is in the form of curtains.

FIG. 3 illustrates a display screen of a viewing device displaying an alternative signal.

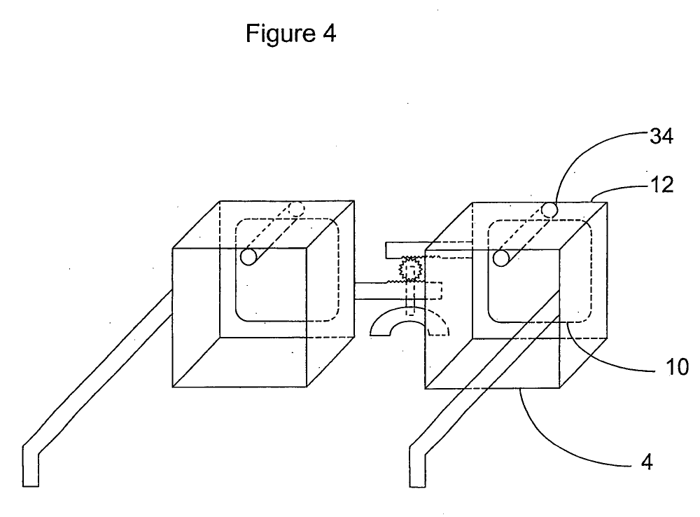

FIG. 4 illustrates a schematic view of a further embodiment of a viewing device with alignment means in the form of tubular structures.

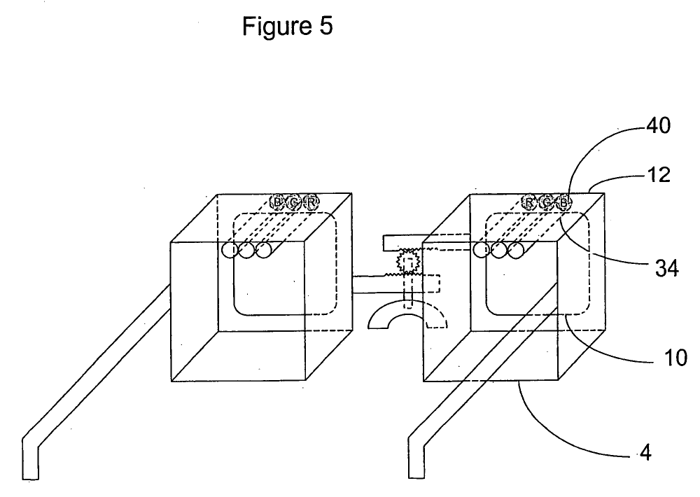

FIG. 5 illustrates a schematic view of a viewing device with alignment means in the form of tubular structures including LEDs.

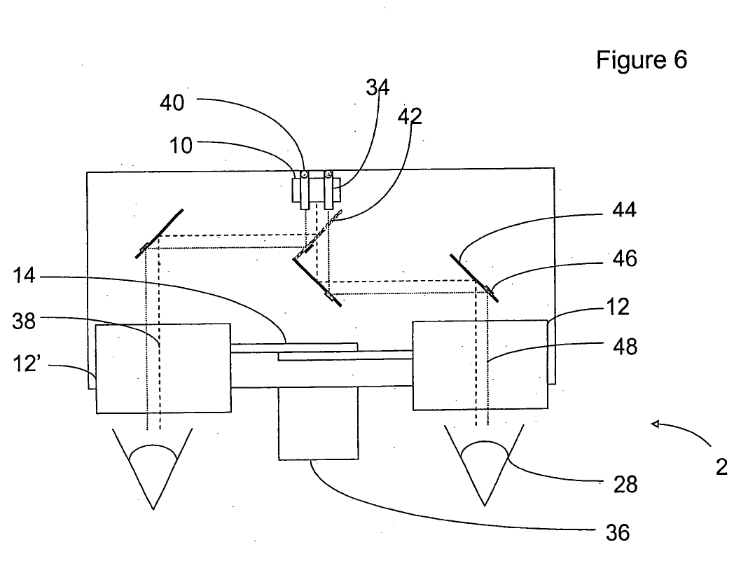

FIG. 6 illustrates a schematic plan view of a yet further embodiment of the invention.

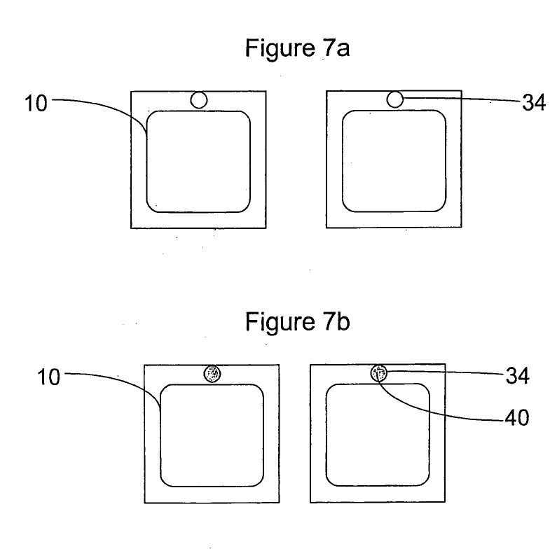

FIG. 7 illustrates the view of the display screens with the alignment means in the form of tubular structures; (a) where the device is misaligned; and (b) where the device is correctly aligned.

With reference to FIG. 1, there is illustrated a viewing device 2 for wearing on the head of a user, comprising two portions 12, 12′, each portion designed to be placed in front of a user's eye. Each portion includes a lens 4 mounted in the front of the portion and an electronic display screen 10 mounted in the rear of the portion. Arms 22 are connected to each portion to allow the user to wear the device and view the screens 10 via the lenses 4.

The horizontal distance between the portions 12, 12′ can be adjusted to match the user's interocular distance by adjustment means in the form of a rack and pinion mechanism 14, 16. The rack and pinion arrangement ensures that the distance each eyepiece relative to the centre of the viewing device remains the same during all adjustments.

In addition the user can adjust the vertical height of the device relative to their eyes by a mechanism 18 connected to the nose bridge 20. This mechanism can also allow lateral movement of the bridge 20 relative to the pinion 16 to correct for a user whose nose is not exactly midway between their eyes, which would otherwise lead to misalignment of the device. Adjustable mounting points (not shown) can also be provided on the bridge 20 to achieve a similar effect.

Alignment means in the form of an aperture 8 acting as an iris, and herein referred to as such, are provided in each portion to allow selective viewing of the screens 10 via the lenses 4.

Referring to FIG. 2b, the iris 8 is capable of adjustment between an open configuration in which the view of the screen is unobstructed, to a configuration in which the iris contracts to a smaller aperture size as shown, only allowing a small part of the screen 10 to be seen. The screens in this example each display an alignment signal in the form of lines 26, so that the user can verify that the device is aligned when each cross is visible through the apertures using their eyes 28.

Referring to FIG. 2a, the alignment means is in the form of a slotted aperture with shutters or curtains 24 which can be moved to reduce the size of the slot aperture and hence restrict the view of the screen 10 as hereinbefore described.

With reference to FIG. 3, the screen 10 is provided with alignment indicators in the form of a central line 26 and additional lines 30 marking “comfort zones” to allow the user to compensate for ocular defects. The screen can also display red or other coloured zones 32 which represent misalignment of the viewing device if visible through the alignment means.

With reference to FIG. 4, a further embodiment is shown in which the alignment means are in the form of tubular structures 34 mounted in each portion. The diameter of the tubular structures is substantially smaller than the diameter of the lenses, typically 1-2 mm. To check if the viewing device is correctly aligned to a user's eye or eyes, the user moves the portions until their eyes can look through the tubular structures. If they cannot look through both tubular structures simultaneously, the viewing device requires adjustment to alter the distance between the portions until it is possible to line the user's eyes up with the image viewed or reference marks through the tubular structures to ensure correct alignment.

With reference to FIG. 5, an embodiment is illustrated similar to that of FIG. 4, but wherein arrays of tubular structures are provided in each portion, with illumination means at the distal ends of each tubular structure in the form of LEDs 40. In the example shown each array contains three tubular structures, containing red, green, and blue LEDs (indicated as R, G, and B respectively).

Thus during alignment, when the portions are too close together, the user sees the blue LEDs, and when too far apart, the user sees the red LEDs. Being able to see the green LEDs represents correct alignment of the device to the user's eyes.

The lines of sight from the user's eyes are thus typically parallel when the green LEDs are visible, but a user may be more comfortable if their eyes are converging slightly and thus the user can adjust the device to view the blue LEDs such that the users eyes converge as a result. Alternatively, the device allows the view to be corrected for a boss-eyed user for example, whose lines of sight naturally diverge, by aligning with the red LEDs.

The portions are provided with locking means (not shown) to lock the portions in position when the LEDs are switched off, and unlock the portions when the LEDs are switched on so the distance between the same can be adjusted during alignment.

The device can also be provided with sensing means to detect the user's pupils and a small electric motor (not shown), such that during alignment, sensors detect the interocular distance and the motor moves the portions to correctly align the device.

With reference to FIG. 6 there is illustrated a further embodiment of the invention in which the viewing device 2 is supported by the user's nose 36, and is provided with two portions in the form of eyepieces 12, 12′, the distance between the eyepieces adjustable using a mechanism 14, wherein the viewing device is provided with a single display screen 10 for viewing by the user.

Light 38 from the display screen 10 is split by a prism or beam splitter 42 into two paths, directed into the user's respective eyes 28 using mirrors 44. In this example, two LEDs 40 are mounted inside the device above the display screen 10. Supplementary mirrors 46 direct light from the LEDs to the user's eyes. However, only one LED is viewable by each eye due to the layout of the supplementary mirrors and casing design, as indicated by the light paths 48.

It will be appreciated that the tubular structures may be mounted inside the eyepieces to generate a similar effect, in which the device can be determined as being aligned when the LEDs are visible through the tubular structures.

Thus in FIG. 7a, a view of the displays 10 is indicated where the LEDs are not visible through the tubular structures 34 and so the device is misaligned to the user's eyes, whereas in FIG. 7b, the LEDs 40 are visible, the light therefrom represented by shaded areas, through the tubular structures 34 and therefore the device is correctly aligned.

It will be appreciated by persons skilled in the art that only one eyepiece need be provided with an alignment means.

It will be appreciated by persons skilled in the art that the present invention may also include further additional modifications made to the device which does not affect the overall functioning of the device.

1. A viewing device comprising:
one or more portions, each of said portions provided to be placed adjacent one of a user's eyes;
adjustment means to allow movement of at least one of said portions;
at least one display screen for viewing by the user via said one or more portions;
characterized in that alignment means are provided to check the alignment of at least one portion with the respective eye of the user when optimizing viewing of the display via movement of the adjustment means.

2. A viewing device according to claim 1 characterized in that at least two spaced portions are provided, each portion including alignment means.

3. A viewing device according to claim 1 characterized in that each portion is or includes an eyepiece, and includes one or more lenses.

4. A viewing device according to claim 3 characterized in that alignment means are mounted in or adjacent the eyepiece or lens to limit the user's view when checking the alignment of the portions.

5. A viewing device according to claim 3 characterized in that the alignment means are mounted centrally or offset from the centre of at least one eyepiece and/or lens.

6. A viewing device according to claim 1 characterized in that each portion includes a display screen.

7. A viewing device according to claim 1 characterized in that the alignment means comprises one or more tubular structures mounted in or on each portion.

8. A viewing device according to claim 7 characterized in that the tubular structures are mounted adjacent the at least one display screen.

9. A viewing device according to claim 7 characterized in that each tubular structure defines an aperture therethrough such that the user is able to look through each aperture when the portions are correctly aligned.

10. A viewing device according to claim 7 characterized in that each tubular structure is provided with illumination means at the distal end thereof.

11. A viewing device according to claim 10 characterized in that the user is able to see illumination from each tubular structures to determine when the portions are correctly aligned.

12. A viewing device according to claim 10 characterized in that the illumination means includes one or more LEDs or other light source.

13. A viewing device according to claim 10 characterized in that one or more arrays of tubular structures are provided, each array including a plurality of tubular structures, each array being provided with plural illumination means of different colors to represent different alignment configurations.

14. A viewing device according to claim 7 characterized in that means are included to increase the path length of the light passing through the tubular structures to the user's eyes, thereby increasing the accuracy of the alignment.

15. A viewing device according to claim 7 characterized in that one or more tubular structures are mounted substantially centrally above and/or below each display screen.

16. A viewing device according to claim 7 characterized in that one or more tubular structures are mounted offset from the centre of the at least one display screen.

17. A viewing device according to claim 1 characterized in that sensor means are provided to detect a user's interocular distance.

18. A viewing device according to claim 18 characterized in that motor means are provided to allow automatic adjustment of the viewing device to match a user's interocular distance on detecting the same.

19. A viewing device according to claim 1 characterized in that locking means are provided to lock the distance between the portions when the alignment means are not in use.

20. A viewing device according to claim 1 characterized in that the adjustment means allows any or any combination of horizontal, vertical, lateral and/or convergence adjustment of the viewing device relative to the user.

21. A viewing device according to claim 20 characterized in that there is provided a rack and pinion mechanism connected to the portions allows horizontal adjustment of the portions to match the interocular spacing.

22. A viewing device according to claim 20 characterized in that there is provided a gear or other mechanism connected to a nose bridge to allow vertical adjustment of the portions relative to the user.

23. A viewing device according to claim 20 characterized in that the arms are provided to allow lateral movement of the portions relative to the user by selective adjustment of the arms.

24. A viewing device according to claim 20 characterized in that the display screens are rotationally mounted via a mechanism to provide equal and opposite movement of the display screens about a substantially vertical axis for convergence adjustment.

25. A viewing device according to claim 1 characterized in that when the portions are correctly aligned to the user's eyes, the alignment means visible to one eye of the user are different to those visible to the other eye.

26. A viewing device according to claim 1 characterized in that the alignment of the portions can be checked while the device is worn by a user.

27. A viewing device according to claim 1 characterized in that the viewing device comprises a single portion and the adjustment means allows the distance between the portion and a central point between a user's eyes or other convenient location to be adjusted.

28. A viewing device according to claim 1 characterized in that the alignment means comprises at least one aperture the size of which can be selectively adjusted between a substantially open configuration when the alignment means is not in use, and a configuration having a smaller size during alignment.

29. A viewing device according to claim 28 characterized in that the aperture is progressively reduced in size in one or more stages as the correct alignment position is approached.

30. A viewing device according to claim 1 characterized in that the alignment means comprises at least one moveable section provided with a small aperture which can be selectively moved to obscure at least a part of the at least one display screen.

31. A viewing device according to claim 28 characterized in that at least one display screen can display an alignment indicator which is visible to the user via the alignment means when the portions are correctly aligned.

32. A viewing device according to claim 28 characterized in that the alignment indicator includes defined areas of the at least one display screen, to allow the user to adjust the viewing device for comfort.

33. A viewing device according to characterized in that the at least one display screen provides an indication to the user of the alignment configuration of the viewing device.

34. A viewing device according to claim 1 characterized in that the device is provided with memory means to allow one or more alignment configurations to be stored.

35. An alignment device for an interocularly adjustable viewing device, comprising
a tubular structure having a channel therethrough characterized in that when the viewing device is correctly aligned with the user's eyes the aperture of said channel is positioned in front of the user's eyes such that the user can look therethrough.

36. An alignment device according to claim 35 characterized in that the alignment is deemed correct if the user can view an object and/or alignment signal though the apertures.

37. A method of aligning an interocularly adjustable viewing device, comprising
the steps of: positioning each of the ocular units included in the viewing device adjacent a person's respective eyes;
moving the ocular units using adjustment means to allow viewing of a display screen provided in the device;
characterized in that the alignment of the ocular units with the person's eyes can be checked with alignment means while moving the adjustment means to optimize viewing of a display screen.
